(19) United States
(12) Patent Application Publication
(10) Pub. No.: US 2005/0262495 A1
(43) Pub. Date: Nov. 24, 2005

(54) Administration mode for server applications

(75) Inventors: Priscilla C. Fung, Union City, CA (US); Ananthan Bala Srinivasan, San Francisco, CA (US)

Correspondence Address: FLIESLER MEYER, LLP, FOUR EMBARCADERO CENTER, SUITE 400, SAN FRANCISCO, CA, 94111, US

(73) Assignee: BEA Systems, Inc., San Jose, CA (US)

(21) Appl. No.: 10/848,228

(22) Filed: May 18, 2004

(51) Int. Cl. G06F 9/44

(52) U.S. Cl. 717/170

(57) ABSTRACT

In one embodiment, application versioning and production redeployment support is designed to handle application upgrade needs in mission-critical, production environments. With multiple application versions, application availability to both existing and new clients is not interrupted during the process of application upgrade. It also provides the ability to test a new application version before opening it to general public as well as the ability to roll back to previous safe versions if there are any errors in the currently active version. Clients see consistent application versions, irrespective and transparent of all failure conditions, including admin or managed server restarts and/or failover. Administrators can monitor and manage application versions easily with the management Console. Being a software-based solution, it improves upon traditional application upgrade solution by eliminating the need of hardware load-balancers and duplicate cluster/domain configurations and their associated resource requirements and by providing sophisticated management capabilities.

### CROSS REFERENCE TO RELATED APPLICATIONS

The present application is related to the following United States Patents and Patent Applications, which patents/applications are assigned to the owner of the present invention, and which patents/applications are incorporated by reference herein in their entirety:
U.S. patent application Ser. No. 10/XXX,XXX, entitled “PRODUCTION REDEPLOYMENT THROUGH APPLICATION VERSIONING”, filed on May 18, 2004, Attorney Docket No. BEAS1572US0, currently pending.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The current invention relates generally to application redeployment, and more particularly to testing of applications during application redeployment in a production environment.

### BACKGROUND OF THE INVENTION

Mission-critical enterprise applications often require continuous availability. However, from time to time, applications need to be brought down for application upgrades, bug fixing or to introduce new features. In order to ensure continuous availability of applications to clients during such periods, system designers typically configure redundant application environments (domain/cluster configurations) and use hardware load-balancers to route new clients to the new application environment with application upgrades, while leaving existing clients to finish gracefully in the old environment. FIG. 1 illustrates a typical redundant application environment 100 in accordance with the prior art. Environment 100 includes an a primary cluster 118 and a secondary cluster 128. Primary cluster 118 includes administration server 110 and managed servers 112, 114 and 116. Managed server 114 includes application A1, A2 and A3. Secondary cluster 128 includes administration server 120 and managed servers 122, 124 and 126. Managed server 124 includes applications A1, A2′ and A3. Though not illustrated in FIG. 1, all managed servers within a cluster have the same set of applications deployed.

A load-balancer (not shown in FIG. 1) initially routes client requests to the primary cluster 118. During application upgrade, the administrator deploys and tests the new application version of A2, illustrated as A2′, on the duplicate cluster 128. When application A2′ is ready to service client traffic, the load-balancer is configured to route new client requests to the duplicate cluster 128. Existing clients continue to access the old application version in the primary cluster. When the administrator determines that all the in-flight work is done, the administrator can then undeploy the old application version from the primary cluster. If desirable, the administrator may also deploy the new application version on the primary cluster and perform another switch back from the duplicate cluster to the primary cluster.

The approach of the prior art requires a hardware load-balancer and a duplicate cluster/cluster configuration for the duration of the application upgrade process. It also requires considerable manual configuration efforts from the administrator and there is also no automatic support for determining when in-flight work is done for a particular application. What is needed is a reliable, automatic system for implementing production redeployment that saves hardware resources and allows administrators to test applications more thoroughly before deploying them.

### SUMMARY OF THE INVENTION

In one embodiment, the present invention includes a system and method for a reliable, automatic system for testing and analysis of applications during production redeployment that saves hardware resources and provides for greater flexibility, administration and control. The system of the present invention supports the notion of application versioning, such that multiple versions of an application can be deployed side-by-side to co-exist in an application server cluster. This allows application upgrades, in the form of a new application version, to be applied to the same application environment as the existing application. The new application version is essentially a separate copy of the application and is fully isolated from the old application version as far as application-scoped resources are concerned, such as application-scoped JDBC connection pools or JMS destinations, all application components and administrative MBeans. The applications may share global resources (global JDBC connection pools or JMS destinations) accessed in the application. The application server system of the present invention may automatically route new clients to the new application version and retire the old application version according to the specified retirement policy.

An application versioning and production redeployment support system in accordance with one embodiment of the present invention is configured to handle application upgrade needs in mission-critical, production environments. With multiple application versions, application availability to both existing and new clients is not interrupted during the process of application upgrade. Application versioning also provides the ability to test a new application version before providing it to be used by clients as well as the ability to roll back to safe previous versions of applications if there are any errors in the currently active version. Moreover, clients can collectively interact with consistent application versions, irrespective and transparent of all failure conditions, including administrative or managed server restarts and/or failover. Administrators can monitor and manage application versions easily with a management console, command line tool, or some other type of interface. The system of the present invention improves upon traditional application upgrade solution by eliminating the need for hardware load-balancers and duplicate cluster/cluster configurations and their associated resource requirements and providing sophisticated management capabilities. In one embodiment, the application server system of the present invention supports self-contained applications having whose entry point is HTTP, inbound JMS messages to MDBs from global JMS destinations, and inbound JCA requests. In one embodiment, the application versioning system of the present invention may be implemented within a application server system such as WebLogic Server, by BEA Systems, of San Jose, Calif.

### BRIEF DESCRIPTION OF THE DRAWINGS

FIG. 1 is an illustration of a system for implementing production redeployment in accordance with the prior art.

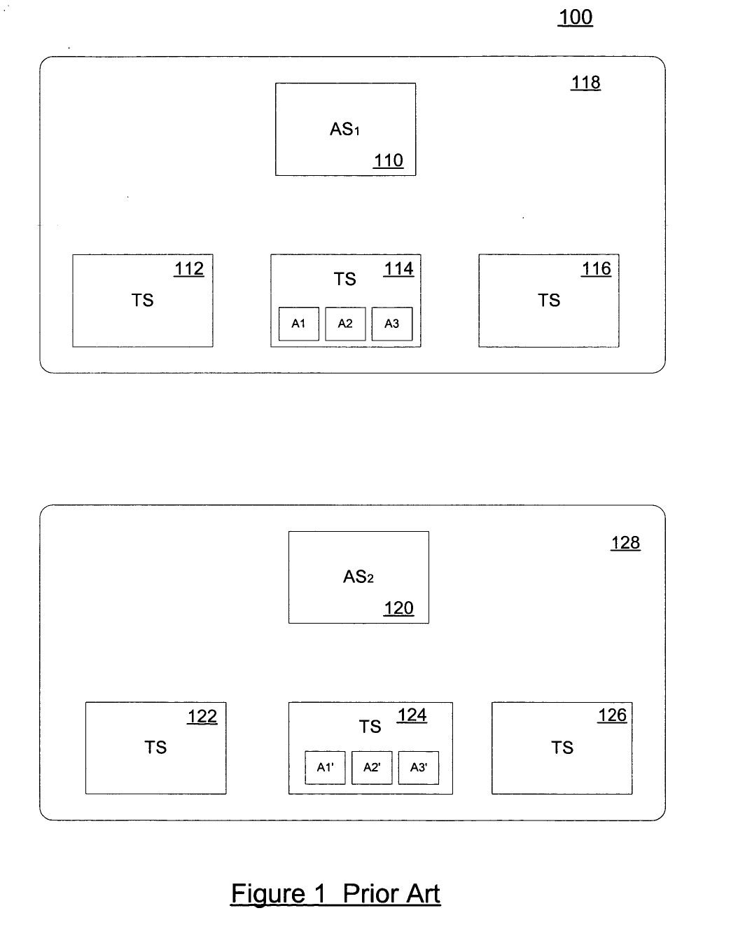

FIG. 2 is an illustration of a system for implementing production redeployment in accordance with one embodiment of the present invention.

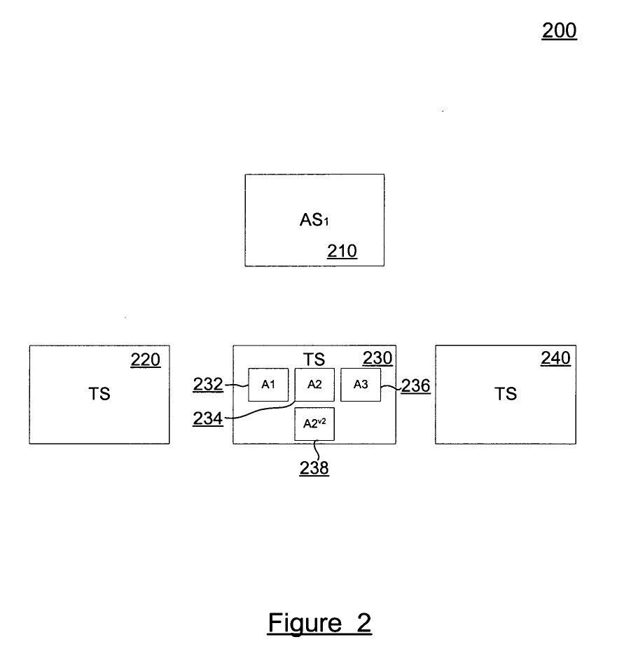

FIG. 3 is an illustration of a method for implementing deployment of an application in accordance with one embodiment of the present invention.

FIG. 4 is an illustration of a method for implementing application retirement in accordance with one embodiment of the present invention.

FIG. 5 is an illustration of a method for implementing rollback to previous application versions in accordance with one embodiment of the present invention.

FIG. 6 is an illustration of application interactions and contexts in accordance with one embodiment of the present invention.

FIG. 7 is an illustration of JNDI bindings in accordance with one embodiment of the present invention.

FIG. 8 is an illustration of an internal state machine for deployment in accordance with one embodiment of the present invention.

FIG. 9 is an illustration of an externally visible state machine in accordance with one embodiment of the present invention.

### DETAILED DESCRIPTION

In one embodiment, the present invention includes a system and method for a reliable, automatic system for testing and analysis of applications during production redeployment that saves hardware resources and provides for greater flexibility, administration and control. The system of the present invention supports the notion of application versioning, such that multiple versions of an application can be deployed side-by-side to co-exist in an application server cluster. This allows application upgrades, in the form of a new application version, to be applied to the same application environment as the existing application. The new application version is essentially a separate copy of the application and is fully isolated from the old application version as far as application-scoped resources are concerned, such as application-scoped JDBC connection pools or JMS destinations, all application components and administrative MBeans. The applications may share global resources (global JDBC connection pools or JMS destinations) accessed in the application. The application server system of the present invention may automatically route new clients to the new application version and retire the old application version according to the specified retirement policy.

An application versioning and production redeployment support system in accordance with one embodiment of the present invention is configured to handle application upgrade needs in mission-critical, production environments. With multiple application versions, application availability to both existing and new clients is not interrupted during the process of application upgrade. Multiple application versioning also provides the ability to test a new application version before providing it to be used by clients as well as the ability to roll back to safe previous versions of applications if there are any errors in the currently active version. Moreover, clients can collectively interact with consistent application versions, irrespective and transparent of all failure conditions, including administrative or managed server restarts and/or failover. Administrators can monitor and manage application versions easily with a management console, command line tool, or some other type of interface. The system of the present invention improves upon traditional application upgrade solution by eliminating the need for hardware load-balancers and duplicate cluster/cluster configurations and their associated resource requirements and providing sophisticated management capabilities. In general, the application server system of the present invention supports self-contained applications having whose entry point is HTTP, inbound JMS messages to MDBs from global JMS destinations, and inbound JCA requests. In one embodiment, the application versioning system of the present invention may be implemented within a application server system such as WebLogic Server, by BEA Systems, of San Jose, Calif.

In one embodiment, when an application developer releases an application upgrade in the form of a new application archive (J2EE EAR), the developer can, using the system of the present invention, indicate that the application upgrade is a new version of the application by including a new version identifier. In one embodiment, these versionable applications will have both an application name and a version identifier, together uniquely identifying a particular version. In one embodiment, the new version identifier is a main attribute specific to the application server system and located in an archive manifest file, and may be a string or some other type of variable.

For example, in an embodiment wherein the version identifier is specific to Weblogic Server, an application archive whose version is “v1” could have the following manifest content:
Manifest-Version: 1.0
Created-By: 1.4.1_{—}05-b01 (Sun Microsystems Inc.)
Weblogic-Application-Version: v1

In one embodiment, the application archive version may be a string and contain characters including but not limited to: alphanumeric (such as“A”-“Z”, “a”-“z”, “0”-“9”), period (“.”), underscore (“_”), and hyphen (“-”). In one embodiment, the version identifier can be any length. In another embodiment, the length of the version identifier should be less than 215 characters.

In one embodiment, a user may specify the application archive version upon initial deployment of the application. In this case, the application server system of the present invention may designate the deployed application as non-versionable. In one embodiment, if no designation is made, the application server of the present invention will designate the application as non-versionable by default.

In another embodiment, during redeployment for versionable applications, if a new application archive version is specified, the application server of the present invention will perform production redeployment with version isolation (thus, generate duplicate versions of the application). In one embodiment, if the same application archive version is specified, the application server of the present invention will perform in-place redeployment, unless there are changes to bindings in the deployment plan, in which case the application server will perform production redeployment also.

In one embodiment, several MBeans may be used to implement the version aware redeployment methodology of the present invention. The ApplicationMBean (or DeploymentBean) is one such MBean. The ApplicationMBean class's “Name” attribute can be made version-aware in that it will not be the name of the application, but will be the application identifier for the application version. There will be an “ApplicationName” attribute which returns the name of the application.

In one embodiment, the ApplicationMBean may also have the following additional attributes:

TABLE 1
ApplicationMBean Attributes

| Name | Value |
|---|---|
| ApplicationName | A string which is the name of the application |
| VersionIdentifier | A string which uniquely identifies the current |
| | application version across all versions of the |
| | same application |
| ArchiveVersion | A string which is the version of the application |
| | archive as specified in the archive manifest file |
| PlanVersion | A string which is the version of the deployment |
| | plan associated with the current deployed |
| | application version |
| ApplicationIdentifier | A string which uniquely identifies the current |
| | application version across all applications and |
| | versions |

In one embodiment, ClusterMBean may have factory APIs to create/delete Application MBeans as well as a navigation API for looking up Application MBeans based on the application identifier. In one embodiment, helper methods may also be provided in a weblogic.application.utils.ApplicationVersionUtils class to manipulate various version-related parameters and to lookup the active version of MBeans.

In one embodiment, an ApplicationRuntimeMBean may be versioned. The versioning may be implemented by having the version identifier appended to the current name of the MBean. In one embodiment, the ApplicationRuntimeMBean may have the following attributes:

TABLE 2
ApplicationRuntimeMbean Attributes

| Name | Value |
|---|---|
| ApplicationName | A string which is the name of the |
| | application |
| VersionActive | A Boolean indicating whether the current |
| | application version is currently active. |
| VersionRedeployTimeMillis | A long indicating the time that the |
| | redeployment of the current version is |
| | initiated. |

With regard to the Version Active attribute, the currently active version may not be the latest redeployed version, since users can rollback to a previous version. All the other MBeans that are the descendents of the ApplicationMBean and ApplicationRuntimeMBean will also be versioned. In one embodiment, the versioning is implemented by having the version identifier appended to an MBean's current name.

In one embodiment, each application version will have its own local JNDI tree, which will be version-unaware. During deployment, the correct versions of the components will be bound to it. For the global JNDI tree, the bind, unbind, rebind, and lookup APIs will be made version-aware. In particular, it will obtain the application name and version identifier from the application context and perform operations on the specific versions of the components. Initial JNDI lookup from clients will return the currently active version of the component. Subsequent access from clients to other components of the application will return components from the same application version.

In one embodiment, J2EE application components that are bound to the JNDI tree, such as EJB homes, JCA resource adapter factories, application-scoped JDBC connection pools and JMS destinations, are also bound in a version-aware manner. Global JNDI lookup of the J2EE application components will return the version of the components as specified in the WorkContext. If no application version has been assigned yet, JNDI lookup will return the currently active (usually the newest) application version. In one embodiment, any custom components that an application version binds to the global JNDI tree will be bound in a version-aware manner.

In one embodiment, when an administrator redeploys the new application archive in the production environment, the application server of the present invention may automatically deploy the new application version side-by-side with the old application version. In one embodiment, the administrator can also specify the retirement policy upon deploying/redeploying an application version so that it may wait till all in-flight work is done or after a specified timeout period.

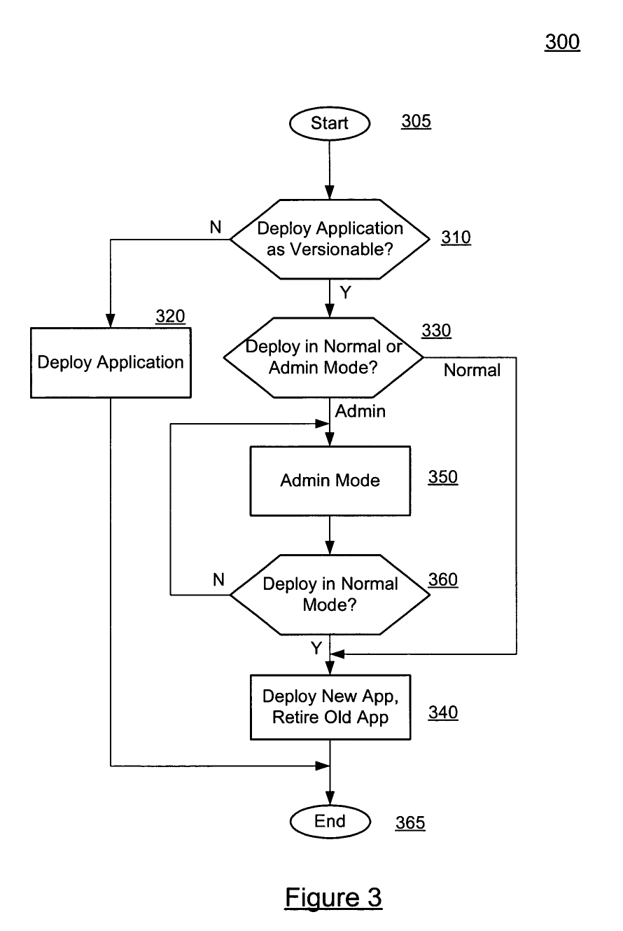

A method 300 for deploying a new application in an application server environment is illustrated in FIG. 3 in accordance with one embodiment of the present invention. Method 300 begins with start step 305. Next, the system determines whether to deploy the new application as versionable or not at step 310. In one embodiment, this determination is made based on administrator input. If the new application is not to be deployed as versionable, operation continues to step 320. At step 320, the application is deployed as non-versionable and operation continues to end step 365. If the application is to be deployed as versionable, operation continues to step 330.

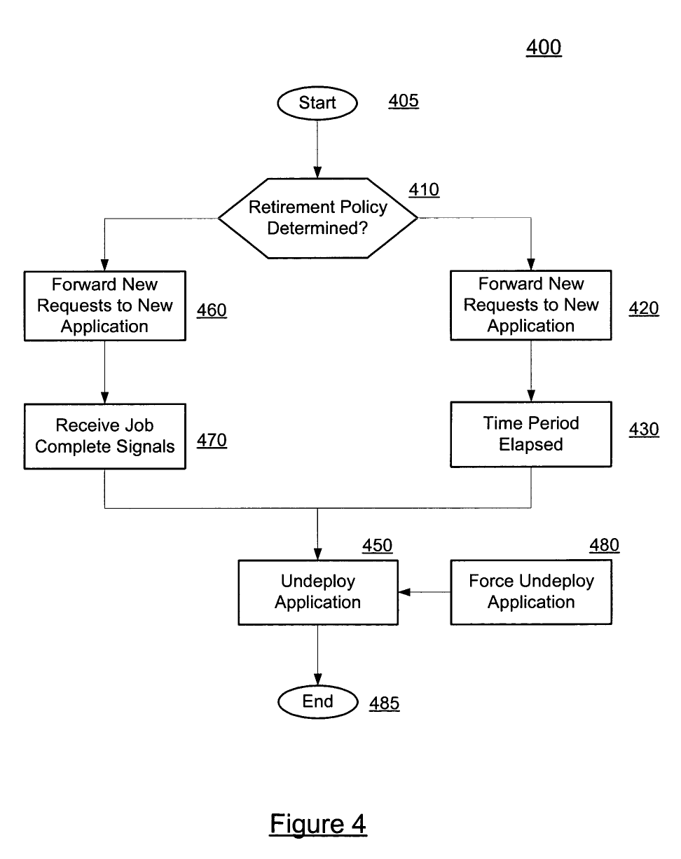

At step 330, the system of the present invention determines whether to deploy the versionable application in normal mode or administrative mode. If the application is to be deployed in normal mode, operation continues to step 340 where the application is deployed as a new application the old application is retired. Step 340 is described in more detail with respect to method 400 of FIG. 4. If the application is to be deployed in the administrative mode, operation continues to step 350. At step 350, the application is in administrative mode wherein the administrator may perform tests on the application without affecting any active applications. Once the administrator determines that the application should be made active and deployed in the normal mode at step 360, operation continues to step 340. After the application is deployed, operation ends at step 365.

Users may specify the retirement policy of the application version when performing production redeployment of versionable applications. Retirement policies in accordance with one embodiment of the present invention are displayed below in Table 3.

TABLE 3
Retirement Policies

| Policy | Description |
|---|---|
| RETIREMENT_VERSION_TIMEOUT | The version will be |
| | retired a specified |
| | timeout period after |
| | the new application |
| | version is active. |
| RETIREMENT_GRACEFUL | The version will be |
| | retired after all the |
| | in-flight work is done. |

FIG. 4 illustrates a method 400 for implementing application retirement policies in accordance with one embodiment of the present invention. Method 400 begins with start step 405. Next, the retirement policy to implement is determined at step 410. In one embodiment, the retirement policy to implement is derived from user input. In another embodiment, the retirement policy is determined automatically from application server conditions. In one embodiment, the default retirement policy is “Complete In-Flight” policy, wherein the application version will be retired after all the in-flight work is complete. In one embodiment, if the retirement policy is determined to be “Complete In-Flight”, then operation continues to step 460 wherein all new application requests from clients are forwarded to the new version of the application. In another embodiment, operation of in-flight operation continues directly from step 410 to step 470. Once job complete signals have been received from all existing in-flight work at step 470, operation continues to step 450 where the old version of the application is undeployed. In another embodiment, the retirement process begins after the new application version is fully deployed and active. In this case, steps 460 and 420 are executed before 410.

If the retirement policy is determined to be a timeout policy at step 410, operation continues to step 420 wherein all new application requests from clients are forwarded to the new version of the application. At step 430, once the designated time period has elapsed, operation continues to step 450 where the old version of the application is undeployed. After the application is undeployed at step 450, operation ends at step 485. In one embodiment, the time elapsed is calculated from the time the new version becomes active. The deployment of the new version may take some time, and when it is done, it will become the active version (in one embodiment, this step is almost instantaneous). Thereafter, all new requests will be routed to the new version. In this embodiment, before deployment of the new version is done, e.g. during the deployment, new requests will still be routed to the old version (which is still the active version at that time).

In one embodiment, at any time during the life of an application, an administrator may force undeploy an application. If the system of the present invention receives input that an administrator wishes to force undeploy an application at step 480, operation immediately proceeds to step 450 where the application is undeployed.

In one embodiment, undeployment of an application version, whether forced by user or due to retirement by system, is coordinated by the administration server and is initiated at all the target servers at the same time.

Sometimes, after a particular application version is deployed in normal mode and is made public, new problems are found which were not caught with previous testing. In one embodiment, the system of the present invention may rollback to a previous application version while the new application version is being fixed. In this case, administrators can redeploy an old application archive (with the old version identifier). The application server of the present invention will automatically make the old redeployed application the currently active application version, whether it is in the process of being retired or it was already undeployed. The problematic application version will then be retired.

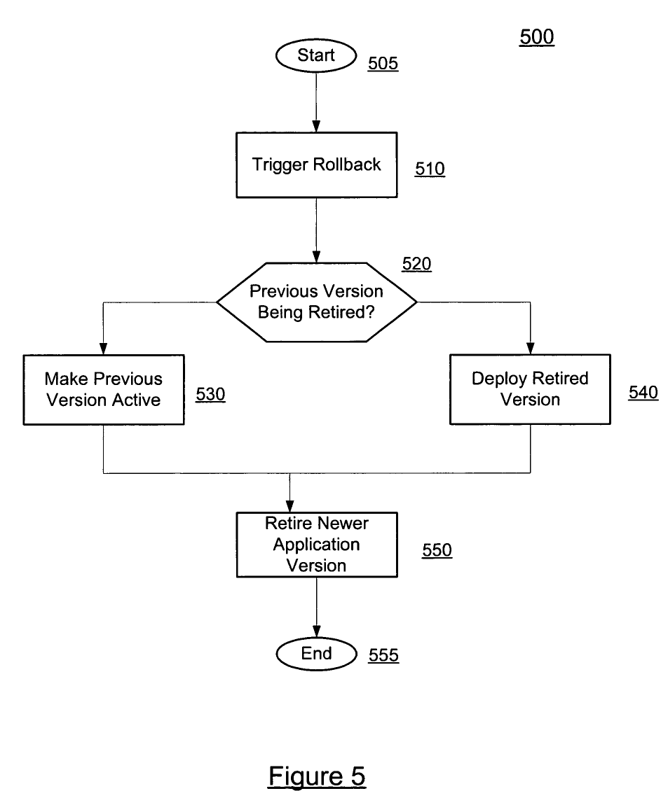

FIG. 5 illustrates a method 500 for implementing rollback to previous application versions. Method 500 begins with start step 505. Next, operation continues to step 510 wherein the system receives input indicating that a rollback to a previous application version should be performed. Next operation continues to step 520 wherein the system determines whether the previous version is in the process of being retired. In one embodiment the previous version may either be completely retired or in the process of being retired. If the previous version is currently in the process of being retired, operation continues to step 530 wherein the version is made the active version. Operation then continues to step 550.

If the previous version is already retired, the retired version of the application is deployed at step 540 and operation continues to step 550. At step 550, the newer version of the application is retired. Operation of method 500 then ends at step 555. Though method 500 was discussed with reference to rollback of a new version of an application to activate an older version, the older version can similarly be rolled back to activate a newer inactive version of the application.

In one embodiment, a configurable ApplicationMBean attribute may specify the maximum number of application versions allowed. In one embodiment, the default number of application versions allowed is two. With two versions, it is possible for the user to rollback to the old version without creating a new application version.

In another embodiment, the administrator can still choose to perform a partial redeploy (which will be done in-place without version isolation) if the application changes are minor and the disruption to existing clients is minimal and acceptable, e.g. updates to static pages.

In one embodiment, Production Redeployment is performed when configured security providers support the application versioning security SSPI. The security providers for authorization, role mapping and credential mapping may support the application versioning SSPI. In one embodiment, security model changes are not implemented between product redeployment. Making security changes while using other security models, or changing the security model may require a stop, undeploy, distribute and start again.

In one embodiment, an administrator can specify a “staged” staging mode, in which the new application archive and its associated files will be copied to a subdirectory (named by the version identifier). If the administrator specifies staging mode “no stage”, then the administrator should use a different staging path for different application versions.

In one embodiment, all application-scoped components of a new application version are version-aware. In an embodiment, this includes parts of the application including the servlets/JSPs, EJB homes, JCA resource adapters, application-scoped JDBC connection pools and JMS destinations.

In one embodiment, when a client first makes an HTTP request to a WebApp application, it will be serviced by the currently active (usually the newest) application version. For stateful WebApps, the version information is retained in the HTTP session, and all subsequent requests from the same client to the application will be serviced by the same application version.

In one embodiment, client requests from the client to the application are serviced by the same application version even when the version is retiring or when requests are being failed over to another server. The version information is also associated with the current thread of execution, so that all subsequent requests from the WebApp to other J2EE application components downstream in the thread recursively will be serviced by the same application version as well. Examples of J2EE application components access downstream include JNDI lookups of other J2EE application components (e.g. EJB homes, JCA resource adapter factories) and JCA 1.5 WorkManager requests (which allow applications to schedule units of work to be executed by the application server).

In one embodiment wherein the application server system is BEA's WebLogic Server, the production redeployment functionality will be exposed as Weblogic extensions to JSR-88 API. For versionable applications, JSR-88 “redeploy” would perform production redeployment with side-by-side versioning. For non-versionable applications, JSR-88 “redeploy” would perform in-place redeployment as before. Moreover, new JSR-88 extension methods will be provided to “deploy”, “start”, and “redeploy” an application version in the admin/test mode, and to open an admin mode application version for general traffic. In any case, the production redeployment functionality can be implemented through an interface that includes a command line tool or a console or workshop.

In one embodiment, clients may retain version “stickiness” to the versions of the applications that it accesses. The default application retirement policy ensures that application versions will only be undeployed when all in-flight work of the clients are done. If the timeout retirement policy is used and the application version is undeployed or if the application version is no longer available for some other reasons, clients will be dispatched to the currently active application version. However, cross-application version stickiness is only retained on a best-effort basis. If clients access applications that recursively access other applications, the system of the present invention will attempt to dispatch requests to the same versions of the recursively-accessed applications if they are available. Nonetheless, the recursively-accessed applications could be undeployed when all its immediate clients are done. As a result, the initial clients may see different versions of the recursively-accessed applications over its lifetime.

In one embodiment, the system of the present invention may enable application code to be transparent of application versioning and continue to use the same API (whether standard J2EE or WebLogic extensions) to access various components. In this case, the application server system of the present invention will perform any necessary version management and dispatching under the covers, as described herein.

In one embodiment, when application code does not incorporate application versioning, application code should not use the application name as an identifier, such as to use the application name as a key to some global maps or database table. Rather, the identifier should be implemented as ApplicationIdentifier instead. Thus, users should use the application identifier (provided by the system) as an identifier for their application's usages.

Example Scenario

An example scenario of the implementation of production redeployment in accordance with one embodiment of the present invention will now be discussed. The scenario will be discussed with reference to BEA Systems' WebLogic Server, but is intended to generally apply use of the present invention with other types of application server environments and systems as well.

Assuming Stefan, the Weblogic administrator, has just received a new application “YABookstoreApp” of version “1.0” (the manifest file of the EAR contains an “Weblogic-Application-Version” attribute with value “1.0”) from development to deploy to their production servers. The application consists of a JSP and some cluster-enabled stateful session beans and entity beans. He uses the console with the new deployment assistant to deploy the application and resolve all the bindings of the application, e.g. it assigns the JNDI path of the ShoppingCartBean home to be “ShoppingCartBeanHome”. The ApplicationMBean that is created for the application will have a name of “YABookstoreApp”, an application identifier of “YABookstoreApp: 1.0”, and its object name will have an extra key property “version” with value “1.0”. The EJB homes will be bound to JNDI tree with an extra name component “1.0” (e.g. The ShoppingCartBean home will be bound under the JNDI name “ShoppingCartBeanHome.1\.0”). For each JNDI binding, there will also be a corresponding binding with the name component “latest” (e.g. Under JNDI path “ShoppingCartBeanHome.latest”, there will be a binding with info (“YABookStoreApp”, “1.0”, <ejb home>)).

When an HTTP client first accesses the application's JSP on Server 1, there is no application version info in the HTTP session. The servlet container routes the request to the latest application version (version “1.0”). It also initiates the application context and the HTTP session to contain: {(“YABookstoreApp”, “1.0”)}. The JSP performs JNDI lookup of the ShoppingCartBean stateful session bean home on Server 2 via the JNDI name ShoppingCartBeanHome. The application context propagates to Server 2 with the JNDI lookup. On Server 2, the JNDI implementation looks up the binding for “ShoppingCartBeanHome.latest”, which returns (“YABookstoreApp”, “1.0”, <ejb home>). After checking the application name and version with those in the application context, JNDI returns version “1.0” of the EJB home for ShoppingCartBean.

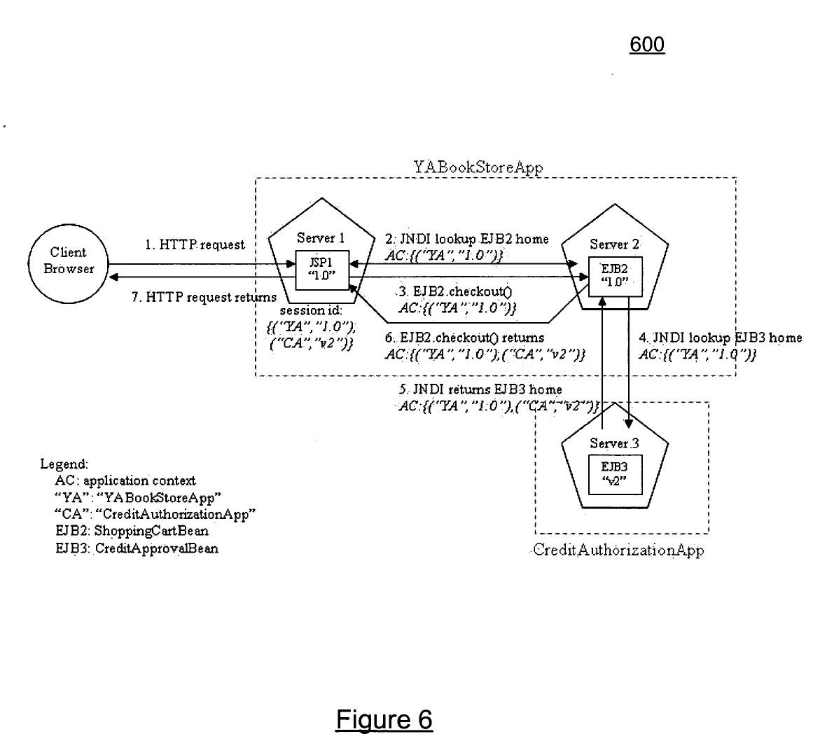

After obtaining the home, the JSP then creates a ShoppingCartBean. Eventually, it calls the checkout method of the ShoppingCartBean. The checkout method in turn accesses another application “CreditAuthorizationApp” to authorize the payment. It looks up another EJB on Server 3 using the JNDI path name “CreditApprovalBeanHome”. On Server 3, the JNDI implementation looks up the binding for “CreditApprovalBeanHome.latest”, which returns (“CreditAuthorizationApp”, “v2”, <ejb home>). JNDI checks the application name and version identifier with those in the application context, and finds that the application “CreditAuthroizationApp” is new. It then adds the tuple (“CreditAuthorizationApp”, “v2”) to the application context, and returns version “v2” of the EJB home for CreditApprovalBean, together with the updated application context: {(“YABookStore”, “1.0”), (“CreditAuthorizationApp”, “v2”) }, to Server 2. The application context is subsequently propagated back to Server 1 when the checkout method returns. The servlet container on Server 1 subsequently updates the HTTP session to include the new tuple also. FIG. 6 illustrates the example scenario application interactions and contexts in accordance with one embodiment of the present invention.

After a while, Stefan receives a new version of the “YABookstoreApp”, version “1.1”, from QA, and he proceeds to redeploy the application in admin mode in order to test out the new version. Stefan does not find any problem with the new application version, and selects the “go live” option from the Console to open the new version for general traffic. The “YABookstoreApp.latest” JNDI binding on Server 2 is now updated to contain (“YABookstoreApp”, “1.1”, <new ejb home>).

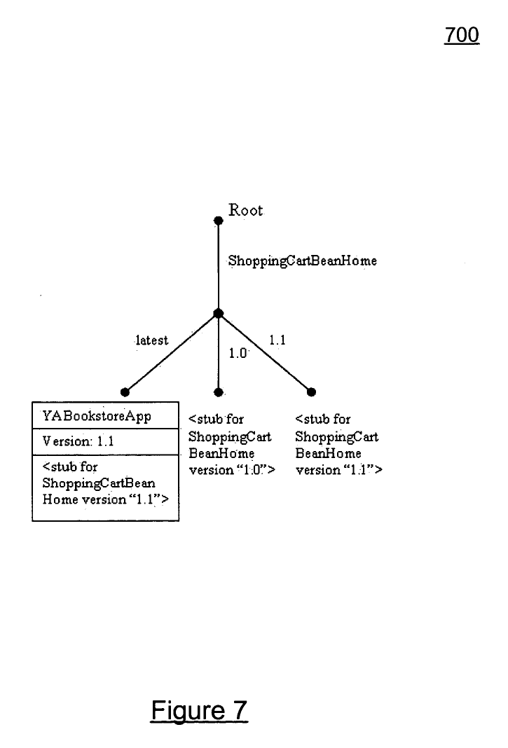

Meanwhile, some existing client sessions are still accessing version “1.0” of “YABookstoreApp”. For those sessions, when they perform JNDI lookup of “ShoppingCartBeanHome”, the JNDI implementation would then return the version “1.0” EJB home. FIG. 7 is an illustration of the example scenario JNDI bindings in accordance with one embodiment of the present invention.

When new client sessions access “YABookstoreApp”, everything happens as described in the “Application Access before redeployment” section above, except that the version identifier will now be “1.1”.

After a while, one of the servers that hosts the JSP of“YABookstoreApp” version “1.1” was brought down for driver upgrades. When the client sessions subsequently try to access the JSP, the proxy plug-in redirects the request to the secondary server. The secondary server obtains the application version info from the replicated HTTP session and continues to work as before.

After some time further, one of the servers that hosts the EJBs of “YABookstoreApp” version “1.0” crashes due to hardware failure. When the client sessions subsequently try to access the EJBs, the replica-aware stubs will detect the server failure and will redirect the request to the secondary server. The replicatable objects on secondary server will have the version identifier and will be able to instantiate the correct version of the EJB to service the request.

Administration Mode

When performing production application upgrades, oftentimes administrators would like to test out the new application version in the production environment before opening it for general traffic. An application administration mode within the application server of the present invention enables administrators to do this.

The administration mode (or admin mode, meaning available for administration’) is a state that an application can reside in. When an application is in the Admin Mode, access to it is restricted through the administration channel. All functionality of that application is available in this mode. When an application is in the Admin Mode, the administrator can resolve problems in the environment, tune various aspects of the application, perform thorough testing of the application and take care of any other administrative aspects of the application. All of this is particularly useful to clusters that are running in production mode.

An application can enter the Admin Mode in two ways. First, it can be deployed to start up in the Admin Mode as illustrated in method 300 of FIG. 3. Alternatively, it can be transitioned into the Admin Mode when it is running or is in general availability mode. This is different then rollback of an application version. An application that is deployed to start up in the Admin Mode will be provided with an option to transition to general availability. By default, applications will start up in general availability mode unless the administrator or deployer explicitly requires that the application start up in Admin Mode. Applications will transition into the Admin Mode if a server is transitioned from the Running to the Admin Mode or if that particular application is transitioned to the Admin Mode.

In one embodiment, a Work Manager may be associated to each application. When configured, additional Work Managers may also be associated with particular modules of the application (such as the Servlet dispatcher). When the application is put into the Admin Mode, the Work Managers associated with that application will reject new work and complete pending work in its queue. When the application transitions from the Admin Mode to the general availability mode, all work directed at the application will be serviced by the Work Manager without being rejected.

While transitioning an application from a running state (also called general availability of normal mode) to the Admin Mode, the application stops accepting requests unless the request has the appropriate context (like a previously created session or a previously created transaction context). This gives an opportunity for any stateful aspects of the application to finish doing their tasks. When all the current work is completed, the application transitions to the Admin Mode.

In one embodiment, to enable the coordinator (such as the Deployment runtime or the Application Container) of the attempt to put the application into Admin Mode to detect when all current work is completed, a completion call back is registered with each module container as part of the first phase of putting an application into Admin Mode. The containers call into the coordinator when all their work is completed. When all such callbacks have replied, the application is considered to be Admin Mode at which point the coordinator is done with that operation.

In one embodiment, the transition from the running mode to the admin mode proceeds as follows. First, the application container requests all modules within its scope to go into the admin mode. Each mode immediately starts filtering new requests. Only requests which access existing sessions or that have a transactional state (EJBs) are accepted. In one embodiment, any attempt to create new transactions or sessions is refused. Requests from administration users are permitted. Each module blocks new requests until the pending state is completed, as the pending state implies transactions and sessions are in progress. Next, the application level work managers begin shutdown. In one embodiment, the work managers complete all requests in the queue and invoke a completion callback. Finally, the application level transaction service is shutdown. In one embodiment, application level transaction service shutdown includes waiting for the transaction count to drop to zero.

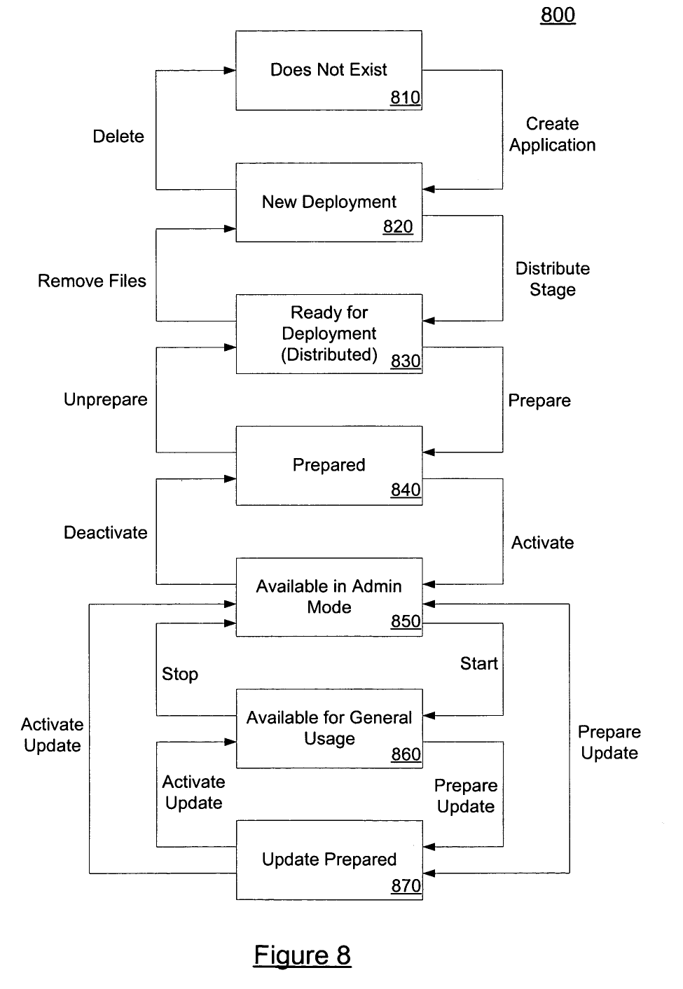

In one embodiment, as a result of introducing the Admin Mode, the Deployment Life cycle state diagram changes a bit. The various internal states and corresponding actions that trigger transitions in the life cycle of deployment in accordance with one embodiment of the present invention is illustrated in FIG. 8. As pictured, internal states include does not exist 810, new deployment 820, ready for deployment (distributed) 830, prepared 840, available in admin mode 850, available for general use 860 and update prepared 870. The arrows connecting the states indicate the action that triggers the transition between the particular states.

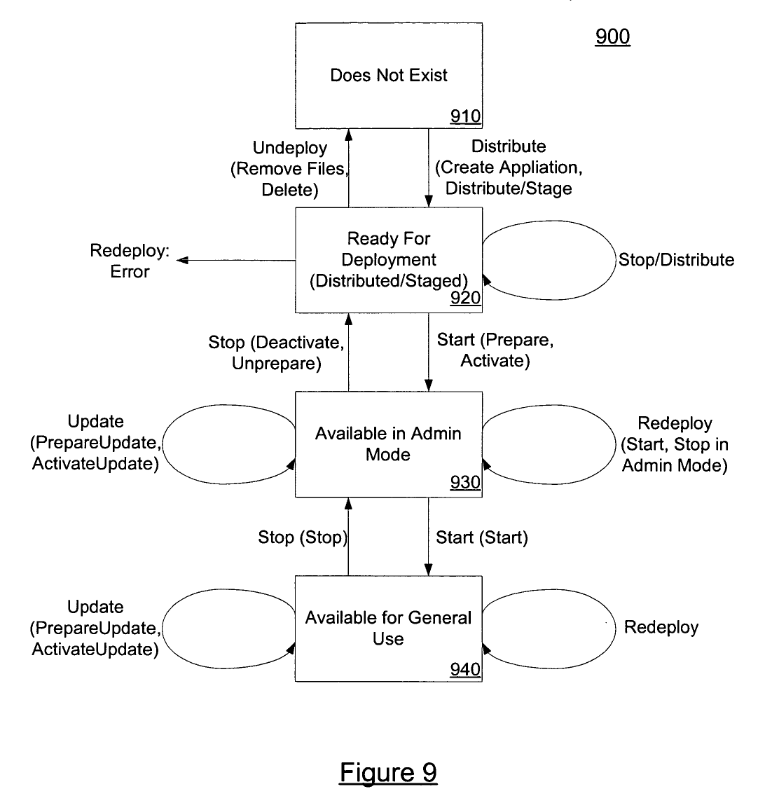

The externally visible states 900 and the Deployment API calls that result in transitions in accordance with one embodiment of the present invention are illustrated in FIG. 9. The states of state machine 900 are does not exist 910, ready for deployment 920, available in admin mode 930 and available for general usage in 940. The arrows connecting the states indicate the action that triggers the transition between the particular states. The arguments to the API calls are the state transitions in the internal state diagram

Currently, the Deployment runtime registers a CallbackHandler with the J2EE Application Container to receive events signaling the state transitions of the various modules or containers. This CallbackHandler can be enhanced with a ‘quiesced()’ method that can be invoked by each of the modules/containers that are part of the application. When an administrator puts an application into admin mode, the deployment runtime signals to the containers on the target servers that they need to quiesce their modules and pass along the reference to the CallbackHandler. When each container is done, it can call the ‘quiesced()’ method on the CallbackHandler.

In one embodiment, the ‘start’, ‘deploy’ and ‘redeploy’ APIs exposed by the deployment subsystem will each have an option—‘enableAdminMode’. When this option is set to ‘true’, the application will ‘start’, ‘deploy’ or ‘redeploy’ and end up in the Admin Mode. By default, this option will not be set and hence the application should transition to general availability as is done today. Since the module containers on the target servers will have this information in the ‘prepare()’/‘activate()’ phases, they can transition automatically to the general availability mode when the ‘enableAdminMode’ is not set.

In one embodiment, the Deployment API may include a call that takes an application in Admin Mode and transitions it to general availability mode. Similarly, the Deployment API may include a call to take a running application and puts it into admin mode. These actions correspond to the ‘Start’ action in the InternalDeploymentStates and ‘Start(Start)’ action in the ExternalDeploymentStates and with the corresponding ‘Stop’ action in the InternalDeploymentStates and the ‘Stop(Stop)’ action in the ExternalDeploymentStates as illustrated in FIGS. 8 and 9.

In one embodiment, Weblogic extensions to the JSR-88 APIs (and associated command tool options) are also available for deploy, start, and redeploy to deploy, start, or redeploy an application version respectively in admin/test mode. In one embodiment, once it is deployed in admin/test mode, the application version is primarily available through the admin network channel and the administrator can perform any necessary testing. After testing, the administrator can use another Weblogic extension to JSR-88 API (and associated command line tool option) to open the application version for general traffic (“go live”). At the same time, the previous application version will be retired.

In one embodiment, administrators can monitor the activity and status of the different application versions (with special indication for the currently active one) via the management Console. In addition, they will be able to visualize the in-flight work for each of the application versions. In one embodiment, the in-flight work includes the number of outstanding HTTP sessions and in-flight transactions for each application version. Moreover, they would be able to perform deployment operations (redeploy, undeploy, rollback etc) and specify retirement policies on the various application versions via the management Console. This allows them to fully monitor the status of the different application versions and manage them effectively and effortlessly.

The application versioning and the production redeployment support is designed to handle application upgrade needs in mission-critical, production environments. As such, application availability, consistency, and management are of paramount concern. With multiple application versions, application availability to both existing and new clients is not interrupted during the process of application upgrade. It also provides the ability to test a new application version before opening it to general public as well as the ability to roll back to previous safe versions if there are any errors in the currently active version. Moreover, conscious design efforts have ensured that all clients will see consistent application versions, irrespective and transparent of all failure conditions, including admin or managed server restarts and/or failover. Last but not the least, administrators can monitor and manage application versions easily with the management Console. Being a software-based solution, it improves upon traditional application upgrade solution by eliminating the need of hardware load-balancers and duplicate cluster/cluster configurations and their associated resource requirements and by providing sophisticated management capabilities.

Other features, aspects and objects of the invention can be obtained from a review of the figures and the claims. It is to be understood that other embodiments of the invention can be developed and fall within the spirit and scope of the invention and claims.

The foregoing description of preferred embodiments of the present invention has been provided for the purposes of illustration and description. It is not intended to be exhaustive or to limit the invention to the precise forms disclosed. Obviously, many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

In addition to an embodiment consisting of specifically designed integrated circuits or other electronics, the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art.

The present invention includes a computer program product which is a storage medium (media) having instructions stored thereon/in which can be used to program a computer to perform any of the processes of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications.

Included in the programming (software) of the general/specialized computer or microprocessor are software modules for implementing the teachings of the present invention, including, but not limited to, production redeployment of applications using versioning.

1. A method for deploying an application in an application server cluster comprising:
generating a second version of the application, the second version of the application including changes from a first version of the application deployed in a first channel provided by a server of the application server cluster;
deploying the second version of the application in an administration channel provided by another server of the application server cluster;
testing the second version of the application in the administration channel; and
deploying the second version of the application in the first channel after the application has been tested.

2. A method for deploying an application in an application server cluster comprising:
deploying a second version of the application in an administration channel provided by a server of the application server cluster, the second version of the application based upon a first version of the application deployed in a first channel;
testing the second version of the application in the administration channel; and
replacing the first version of the application in the first channel with the second version of the application.

3. The method of claim 2, wherein deploying a second version of the application in an administration channel provided by a server of the application server cluster, the second version of the application based upon a first version of the application deployed in a first channel comprises:
applying at least one revision to the first version of the application deployed in the first channel to form the second version of the application in the administration channel; wherein the first channel and the administration channel are provided by at least one of a set of servers of the application cluster.

4. The method of claim 2, wherein testing the second version of the application in the administration channel comprises:
testing the second version of the application substantially concurrently with operating the first version of the application.

5. The method of claim 4, wherein testing the second version of the application substantially concurrently with operating the first version of the application comprises:
providing access to the second version of the application for testing substantially concurrently with providing existing clients access to the first version of the application.

6. The method of claim 2, wherein replacing the first version of the application in the first channel with the second version of the application comprises:
automatically routing new clients to the second version of the application.

7. The method of claim 6, wherein automatically routing new clients to the second version of the application comprises:
automatically routing new clients to the second version of the application after lapse of a specified time period after the second version of the application becomes active.

8. The method of claim 6, wherein automatically routing new clients to the second version of the application further comprises:
retiring the first version of the application according to a retirement policy.

9. The method of claim 6, wherein automatically routing new clients to the second version of the application further comprises:
automatically routing new clients to the second version of the application after pending work for the first version of the application is completed.

10. The method of claim 2, further comprising:
rolling back to the first version of the application in the event that problems are discovered with the second version of the application.

11. The method of claim 2, further comprising:
isolating the second version of the application and the first version of the application from one another.

12. The method of claim 2, further comprising:
sharing resources among the second version of the application and the first version of the application.

13. A computer-readable medium carrying one or more sequences of instructions for deploying a second version of an application in an application server cluster on which a first version of the application is deployed, which instructions, when executed by one or more processors, cause the one or more processors to carry out the steps of:
deploying a second version of the application in an administration channel provided by a server of the application server cluster, the second version of the application based upon a first version of the application deployed in a first channel;
testing the second version of the application in the administration channel; and
replacing the first version of the application in the first channel with the second version of the application.

14. The computer-readable medium as recited in claim 13, wherein the instructions for deploying a second version of the application in an administration channel provided by a server of the application server cluster, the second version of the application based upon a first version of the application deployed in a first channel include instructions, which when executed by one or more processors, cause the one or more processors to carry out the step of:
applying at least one revision to the first version of the application deployed in the first channel to form the second version of the application in the administration channel; wherein the first channel and the administration channel are provided by at least one of a set of servers of the application cluster.

15. The computer-readable medium as recited in claim 13, wherein the instructions for testing the second version of the application in the administration channel include instructions, which when executed by one or more processors, cause the one or more processors to carry out the step of:
testing the second version of the application substantially concurrently with operating the first version of the application.

16. The computer-readable medium as recited in claim 15, wherein the instructions for testing the second version of the application substantially concurrently with operating the first version of the application include instructions, which when executed by one or more processors, cause the one or more processors to carry out the step of:
providing access to the second version of the application for testing substantially concurrently with providing existing clients access to the first version of the application.

17. The computer-readable medium as recited in claim 13, wherein the instructions for replacing the first version of the application in the first channel with the second version of the application include instructions, which when executed by one or more processors, cause the one or more processors to carry out the step of:
automatically routing new clients to the second version of the application.

18. The computer-readable medium as recited in claim 17, wherein the instructions for automatically routing new clients to the second version of the application include instructions, which when executed by one or more processors, cause the one or more processors to carry out the step of:
automatically routing new clients to the second version of the application after lapse of a specified time period after the second version of the application becomes active.

19. The computer-readable medium as recited in claim 17, wherein the instructions for automatically routing new clients to the second version of the application include instructions, which when executed by one or more processors, cause the one or more processors to carry out the step of:
retiring the first version of the application according to a retirement policy.

20. The computer-readable medium as recited in claim 17, wherein the instructions for automatically routing new clients to the second version of the application include instructions, which when executed by one or more processors, cause the one or more processors to carry out the step of:
automatically routing new clients to the second version of the application after pending work for the first version of the application is completed.

21. The computer-readable medium as recited in claim 13, further comprising instructions, which when executed by one or more processors, cause the one or more processors to carry out the step of:
rolling back to the first version of the application in the event that problems are discovered with the second version of the application.

22. The computer-readable medium as recited in claim 13, further comprising instructions, which when executed by one or more processors, cause the one or more processors to carry out the step of:
isolating the second version of the application and the first version of the application from one another.

23. The computer-readable medium as recited in claim 13, further comprising instructions, which when executed by one or more processors, cause the one or more processors to carry out the step of:
sharing resources among the second version of the application and the first version of the application.

24. An apparatus for deploying an application in an application server cluster, the apparatus comprising:
a processor; and
one or more stored sequences of instructions which, when executed by the processor, cause the processor to carry out the steps of:
deploying a second version of the application in an administration channel provided by a server of the application server cluster, the second version of the application based upon a first version of the application deployed in a first channel;
testing the second version of the application in the administration channel; and
replacing the first version of the application in the first channel with the second version of the application.
